(19) United States
(12) Patent Application Publication
(10) Pub. No.: US 2024/0331666 A1
(43) Pub. Date: Oct. 3, 2024

(54) ADJUSTING MUSICAL COMPOSITION DATA USING A COMPUTATIONAL MODEL OF RUBATO

(71) Applicant: Regents of the University of Minnesota, Minneapolis, MN (US)

(72) Inventors: Benjamin Honeray LEE, Minneapolis, MN (US); Guerino Bruno MAZZOLA, Minneapolis, MN (US)

(21) Appl. No.: 18/621,628

(22) Filed: Mar. 29, 2024

Related U.S. Application Data
(60) Provisional application No. 63/455,793, filed on Mar. 30, 2023.

(51) Int. Cl. G10H 1/00

(52) U.S. Cl. CPC G10H 1/0025; G10H 2210/076; G10H 2210/105; G10H 2210/111; G10H 2210/385; G10H 2210/391; G10H 2220/116; G10H 2220/126

(57) ABSTRACT

A musical composition is varied using a computational model of rubato. Rubato is modeled by changes to the symbolic onset and/or symbolic offset of each note, which allows for a greater flexibility in timing modifications, such as asymptotic tempo and localized retrogrades. A user selects notes to be modified (e.g., by plotting points to modify notes over a selected interval), and a curve fitting (e.g., a cubic spline interpolation) is used to determine modifications for other notes in the composition. These symbolic onset/offset modifications may also be translated into tempo modifications. The symbolic onset and/or offset modifications are applied to the composition to produce an adjusted musical composition, to which rubato has been applied. Rubato profiles can similarly be extracted from existing musical recordings and used to characterize the recordings, such as for training machine learning models and recommender systems.

### CROSS-REFERENCE TO RELATED APPLICATIONS

This application claims priority to U.S. Provisional Patent Application No. 63/455,793 filed on Mar. 30, 2023, titled “ADJUSTING MUSICAL COMPOSITION DATA USING A COMPUTATIONAL MODEL OF RUBATO,” the entire contents of which is incorporated herein by reference.

### BACKGROUND

Rubato is a musical term used to describe slight variations in the timings of notes, where certain notes or phrases are played slightly faster or slower than the established score to create a sense of expressiveness and emotion in the music. While rubato is primarily a subjective and artistic concept, it is possible to describe its effect mathematically.

One way to do this is to use the concept of tempo deviation, which measures the difference between the actual onset of a note or phrase and its expected onset based on the established tempo. Tempo deviation can be expressed as a percentage, where positive values below 100% indicate that the note or phrase is played slower than expected, and values above 100% indicate that it is played faster than expected. However, the tempo deviation model of rubato can fail to intuitively capture nuance when a performer either draws out long notes or adds long periods of silence between notes.

### SUMMARY OF THE DISCLOSURE

The present disclosure addresses the aforementioned drawbacks by providing a method for generating an adjusted musical composition. Musical composition data are accessed with a computer system, where the musical composition data includes notes arranged in a temporal sequence. At least one user-selected note in the musical composition data is received by the computer system, and modified notes are generated using the computer system to apply at least one of a symbolic onset modification or a symbolic offset modification for each user-selected note. A rubato profile is generated by performing a curve fitting on the modified notes using the computer system. The adjusted musical composition data are then generated using the computer system by applying at least one of symbolic onset modifications or symbolic offset modifications to other notes in the musical composition data using the rubato profile. The adjusted musical composition data are then stored with the computer system.

It is another aspect of the present disclosure to provide a method for determining a rubato profile for a musical recording. Musical composition data are accessed with a computer system, where the musical composition data include notes arranged in a temporal sequence that define a musical score. Musical recording data are also accessed with the computer system, where the musical recording data include an audio recording of a performance of the musical score represented by the musical composition data. A rubato profile for the musical recording data is determined by the computer system based on a comparison of the musical recording data and the musical composition data. The rubato profile is then stored with the computer system.

The foregoing and other aspects and advantages of the present disclosure will appear from the following description. In the description, reference is made to the accompanying drawings that form a part hereof, and in which there is shown by way of illustration one or more embodiments. These embodiments do not necessarily represent the full scope of the invention, however, and reference is therefore made to the claims and herein for interpreting the scope of the invention.

### BRIEF DESCRIPTION OF THE DRAWINGS

FIG. 1 is a visual representation of ritardando on the first and second notes of a phrase. A period of silence separates the first note with onset e_{orig,1} and offset o_{orig,1} from the second note with onset e_{orig,2} and offset o_{orig,2}. The each-note modifications e₁*, o₁*, e₂*, and o₂* are then summed to get the final onset/offset modifications e₁^{Ω}, o₁^{Ω}, e₂^{Ω}, and o₂^{Ω}.

FIG. 2 is a visual representation of accelerando on the first and second notes of a two-note phrase. A period of silence separates the first note with onset e_{orig,1} and offset o_{orig,1} from the second note with onset e_{orig,2} and offset o_{orig,2}. The each-note modifications e₁*, o₁*, e₂*, and o₂* are then summed (but in the opposite direction of ritardando from FIG. 1) to get the final onset/offset modifications e₁^{Ω}, o₁^{Ω}, e₂^{Ω}, and o₂^{Ω}.

FIG. 3 is a visual representation of accelerando on the first note and ritardando on the second note in a two-note phrase. A period of silence separates the first note with onset e_{orig,1} and offset o_{orig,1} from the second note with onset e_{orig,2} and offset o_{orig,2}. The each-note modifications e₁*, o₁*, e₂*, and o₂* are then either added or subtracted from one another depending on whether they represent accelerando or ritardando to get the final onset/offset modifications e₁^{Ω}, o₁^{Ω}, e₂^{Ω}, and o₂^{Ω}.

FIG. 4 is a visual representation of ritardando on the first note and accelerando on the second note in a two-note phrase. A period of silence separates the first note with onset e_{orig,1} and offset o_{orig,1} from the second note with onset e_{orig,2} and offset o_{orig,2}. The each-note modifications e₁*, o₁*, e₂*, and o₂* are then either added or subtracted from one another depending on whether they represent accelerando or ritardando to get the final onset/offset modifications e₁^{Ω}, o₁^{Ω}, e₂^{Ω}, and o₂^{Ω}.

FIG. 5 is a flowchart setting forth the steps of an example method for adjusting a musical composition using a computational model of rubato.

FIG. 6 is an example graphical user interface (“GUI”) for applying onset modifications to a musical composition and for generating a rubato profile based on the user-selected onset modifications.

FIG. 7 is an example GUI for applying offset modifications to a musical composition and for generating a rubato profile based on the user-selected offset modifications.

FIG. 8 is another example GUI for applying onset and/or offset modifications to a musical composition and for generating a rubato profile based on the user-selected modifications.

FIG. 9 is an example GUI for applying onset and/or offset modifications to a musical composition and for generating a rubato profile based on the user-selected modifications, in which a curve fitting parameter window is displayed to enable user interaction with curve fitting parameters used to generate the rubato profile.

FIG. 10 is a flowchart setting forth the steps of an example method for extracting a rubato profile from a musical recording relative to the corresponding original musical composition.

FIG. 11 is a block diagram of an example computational rubato system for generating adjusted musical compositions and/or extracting rubato profiles from musical recordings.

FIG. 12 is a block diagram of example components that can implement the system of FIG. 11.

### DETAILED DESCRIPTION

Described here are systems and methods for varying a musical composition using a computational model of rubato. In general, the systems and methods described in the present disclosure implement a process in which rubato can be modeled from a mathematical standpoint. For instance, rubato can be modeled as modifications to the symbolic onset and/or symbolic offset of each note. This latter approach has the advantage of being able to capture nuance when dealing with silence between notes, allowing for a more expressive musical composition that is generated and/or modified by a computer-implemented process.

In some examples, the systems and methods can receive musical composition data as an input for processing by a computer system. The musical composition data can include the components of a musical composition or score, such as notes, key signatures, time signatures, tempo, dynamics, articulations, and other components of the musical notations that make up the musical composition or score. A user may then select, via a graphical user interface (“GUI”), one or more notes in the musical composition that should be altered. The alterations may include adding a symbolic onset to a selected note (e.g., so the note is played later in the composition), subtracting a symbolic onset from a selected note (e.g., so the note is played earlier in the composition), adding a symbolic offset to a selected note (e.g., so the note is ended later in the composition), subtracting a symbolic offset from a selected note (e.g., so the note is ended earlier in the score), or combinations thereof. Based on the selected note(s), the computational model can also be applied to convert symbolic onsets and/or symbolic offsets to physical onset and/or physical offset modifications for performing or generating the musical composition. The symbolic onsets and/or symbolic offsets can be implemented using a normal adjustment, in which the duration of the note is reduced based on the symbolic onset and/or symbolic offset modifications; using a legato adjustment, in which the offset of the ith note is set to the onset of the (i+1)th note, which can provide a longer note duration than the normal adjustment; or using a staccato adjustment, in which the offset of each note is set to a constant, user-specified amount of time after the onset of each note. In this way, the computational model of rubato described in the present disclosure is capable of capturing rubato as a set of modifications to individual note timings (i.e., onsets and offsets) in addition to as a series of tempo changes.

As a non-limiting example, the computational model can be fit to the user-selected note(s) to generate a function (e.g., a cubic spline) that represents a rubato profile for the musical composition. In some examples, the rubato profile can be converted into a tempo modification profile for the musical composition (e.g., by altering the onset, duration, and/or offset of notes in the composition).

These techniques can be advantageous for processing a musical composition to provide a more expressive performance of the musical composition; by contrast, if a musical composition is generated using an electronic process it may sound mechanical when performed. Using the systems and methods described in the present disclosure, the musical composition can be quickly adjusted by a user to provide varying degrees of rubato to the composition, so as to provide a more expressive performance of the musical composition. For example, when scoring a film, the user may adjust the rubato profile of the musical composition in real-time while viewing the film, such that the musical composition (and later performed musical piece) will optimally synchronize with the content of the film. In this way, the systems and methods described in the present disclosure can provide an efficient tool for recomposing, or otherwise adjusting, a musical composition to match the content of a film being scored with the musical composition. As an example, the recomposed musical composition can better match the emotional impact of the film, or can better synchronize with the action depicted in the film or the speakers in the film.

In some other examples, a musical recording and its corresponding musical composition are received by the computer system and processed to extract a rubato profile, which may then be altered to adjust the underlying musical composition, or may be stored for use in auxiliary applications. By way of example, the rubato profile can include a mathematical function or curve that indicates a tempo modification in the musical recording relative to the original musical composition. As one non-limiting example, for initial note onsets, Et, and post-modification onsets, Ef, in a musical composition, the modified tempo of the nth note, T f, in the score equivalent to the original onset modification can be determined through the following equation:

$${T}_{f , n} = \frac{{E}_{i , n} - {E}_{i , n - 1}}{{E}_{f , n} - {E}_{f , n - 1}} {T}_{i , n} for n > 1 .$$

Similarly, for initial tempos, Tᵢ, and post-modification tempos, T_{ƒ}, the onset modification ΔEₙ, of the nth note in the score equivalent to the original tempo change can be determined through the following equation:

$$Δ {E}_{n} = \frac{1}{{c}_{n}} ( {E}_{i , n} - {E}_{i , n - 1} ) + {E}_{f , n - 1} - {E}_{i , n} for n > 1 , {c}_{n} = \frac{{T}_{f , n}}{{T}_{i , n}} , {E}_{f , 0} = {E}_{i , 0} = 0 .$$

Using the computational models of rubato described in the present disclosure, the rubato profile can be converted into symbolic onsets and/or symbolic offsets, which can then be modified by the user as described above.

For example, a musical recording can be processed using a computational model of rubato to extract a rubato profile for the musical recording, from which the symbolic onsets and/or symbolic offsets that have been applied when performing the musical composition to generate the musical recording can be determined. The user may then select and adjust the symbolic onsets and/or symbolic offsets of notes in the musical composition. The altered musical composition can then be performed and recorded to generate an adjusted musical recording that has a different musical expression than the original musical recording. These techniques can advantageously be used to adjust a musical composition that, when performed, may yet lack a desired amount of expression.

Additionally or alternatively, the rubato profile extracted from the musical recording can be stored for later use in auxiliary applications. As one non-limiting example, the rubato profile can be used as an input to a machine learning model or other artificial intelligence (“Al”) model. For instance, a recommender system can be trained to recommend music to a user based on various types of input data (e.g., musical artist, composer, genre, beats per minute, emotion, or other characteristics about the musical recordings). In this way, the rubato profile can be used as an additional feature for training a recommender system to recommend music to users (e.g., via a music streaming service, or the like), and thus as an additional input for a trained recommender system.

As yet another example, an extracted rubato profile can be used in other machine learning or Al models, such as those that may be trained to identify musical recordings for use in a music therapy application. For example, the rubato profiles for a collection of musical recordings can be used to train a machine learning or other Al model together with user feedback data on the preference of the musical recordings, or data on how the musical recordings affected the user's mood, emotional state, psychological state, or other condition. In this way, machine learning or other Al models can be constructed to identify whether a new musical recording would be effective for positively affecting the user's mood, emotional state, psychological state, or other condition based on the rubato profile extracted for that new musical recording. In some examples, the rubato profile can therefore be used to determine or otherwise identify timing nuances in music that might affect the human psyche and overall well-being. Additionally or alternatively, the rubato profile can be used to determine or otherwise identify music that may be effective for treatment of patients affected by post-traumatic stress disorder. In yet other examples, the rubato profile may be used to determine or otherwise identify music that may have positive or otherwise therapeutic effects with autism, memory loss, Alzheimer's disease, and/or the effects of aging.

As noted above, the systems and methods described in the present disclosure implement a computational model of rubato that, in some embodiments, takes at least two inputs: a musical score and either a set of symbolic onset modification points, a set of symbolic offset modification points, or both. The two sets of points, E and O, can be defined by the user, where one set is for the onset changes (E) to notes in the score and the other set is for the offset changes (O). In E, the ith row represents the note nᵢ associated with onset change ej, and the jth row of O represents the note nⱼ associated with offset change oj with 1≤i≤E and 1≤j≤0:

$$E = [ \begin{matrix}{n}_{1} & {e}_{1} \\ {n}_{2} & {e}_{2} \\ {n}_{3} & {e}_{3} \\ ⋮ & ⋮ \\ {n}_{E} & {e}_{E}\end{matrix} ] , O = [ \begin{matrix}{n}_{1} & {o}_{1} \\ {n}_{2} & {o}_{2} \\ {n}_{3} & {o}_{3} \\ ⋮ & ⋮ \\ {n}_{o} & {o}_{o}\end{matrix} ] , n ∈ {ℤ}^{+} ; e , o ∈ ℝ$$

As an example, the first row of the matrix E, [n₁ e₁], indicates the amount of onset modification, e₁, applied to note n₁, which is the first modified note of the score (n₁, e₁) plotted by the user. Likewise, the last row of the matrix O, [nₒ oₒ], indicates the amount of offset modification, oo, applied to note no, which is the last modified noted of the score with point (nₒ, oₒ) plotted by the user.

There does not need to be an onset and offset modification for each note in the score. Rather, the onset and offset modifications can be specified for notes over a user-defined range. This also means that n₁ is not necessarily the first note of the score. It could be the third or fifth note in the score. Instead, n₁ indicates the first note of the score whose onset is being modified by a user-defined point. Additionally, the computational model does not require the user to plot the exact same number of onset modification points as offset modification points.

To find the proper amount of onset and offset modification for every note in the score, cubic spline interpolation (or another suitable interpolation technique) can be used on the user-defined sets of points E and O, respectively.

Since there is no guarantee that the user will define the first symbolic onset or offset modification on the first note of the score, a check can be performed to determine if a modification for the first note of the score already exists within E or O. If not, the default onset or offset modification of zero (i.e. the row [nₑ 0]) is appended to the beginning of E or O for every note before the first note modified by the user. A similar process is performed for the last note in the score, appending the row [n_{E} 0] or [no 0] to the end of the matrix if needed.

By defining these rows, the cubic spline interpolation algorithm will generate modification values for all notes within the musical composition, thereby making it easier to assign onset or offset modifications to the score later on.

Based on the user-selected onset and/or offset modification values, each of them can be processed separately using the cubic spline interpolation outlined below, or using another suitable curve fitting or interpolation technique.

First, the following assumptions can be made. The values of the polynomials at the beginning and endpoints should be eᵢ and e_{E}, respectively. Also, the values of internal points eᵢ, i≠1, E are the same regardless of coming from the left cubic polynomial or the right cubic polynomial. Further, the first derivative at any internal point should remain the same regardless of coming from the left or right.

These can be mathematically summarized as:

$$\begin{matrix}1. {p}_{1} ( {n}_{1} ) = {a}_{1} {n}_{1}^{3} + {b}_{1} {n}_{1}^{2} + {c}_{1} {n}_{1} + {d}_{1} = {e}_{1} \\ {p}_{E - 1} ( {n}_{E} ) = {a}_{E - 1} {n}_{E}^{3} + {b}_{E - 1} {n}_{E}^{2} + {c}_{E - 1} {n}_{E} + {d}_{E - 1} = {e}_{E} \\ 2. {p}_{i} ( {n}_{i + 1} ) = {a}_{i} {n}_{i + 1}^{3} + {b}_{i} {n}_{i + 1}^{2} + {c}_{i} {n}_{i + 1} + {d}_{i} = {e}_{i + 1} \\ {p}_{i + 1} ( {n}_{i + 1} ) = {a}_{i + 1} {n}_{i + 1}^{3} + {b}_{i + 1} {n}_{i + 1}^{2} + {c}_{i + 1} {n}_{i + 1} + {d}_{i + 1} = {e}_{i + 1} \\ 3. {p}_{i}^{′} ( {n}_{i} ) - {p}_{i + 1}^{′} ( {n}_{i} ) = ( 3 {a}_{i} {n}_{i + 1}^{2} + 2 {b}_{i} {n}_{i + 1}^{1} + {c}_{i} + 0 ) - ( 3 {a}_{i + 1} {n}_{i + 1}^{2} + \\ 2 {b}_{i + 1} {n}_{i + 1} + {c}_{i + 1} + 0 ) = 0 .\end{matrix}$$

This is a system of linear equations that can be solved. For example, the linear system of equations can be solved using the following equation composed of a (3E - 4)-by-(4E -4) matrix, a (4E - 4)-long vector of coefficients, and a (3E - 4)-long vector of known data values and relationships (dashes have been added to help add borders between each set of equations):

$$[ \begin{matrix}{n}_{1}^{3} & {n}_{1}^{2} & {n}_{1} & 1 & 0 & 0 & 0 & 0 & … & 0 & 0 & 0 & 0 \\ 0 & 0 & 0 & 0 & 0 & 0 & 0 & 0 & … & {n}_{E}^{3} & {n}_{E}^{2} & {n}_{E} & 1 \\ - & - & - & - & - & - & - & - & - & - & - & - & - \\ {n}_{2}^{3} & {n}_{2}^{2} & {n}_{2} & 1 & 0 & 0 & 0 & 0 & … & 0 & 0 & 0 & 0 \\ 0 & 0 & 0 & 0 & {n}_{2}^{3} & {n}_{2}^{2} & {n}_{2} & 1 & … & 0 & 0 & 0 & 0 \\ 0 & 0 & 0 & 0 & {n}_{3}^{3} & {n}_{2}^{3} & {n}_{1}^{3} & 1 & … & 0 & 0 & 0 & 0 \\ ⋮ & ⋮ & ⋮ & ⋮ & ⋮ & ⋮ & ⋮ & ⋮ & ⋮ & ⋮ & ⋮ & ⋮ & ⋮ \\ 0 & 0 & 0 & 0 & 0 & 0 & 0 & 0 & … & {n}_{E - 1}^{3} & {n}_{E - 1}^{2} & {n}_{E - 1} & 1 \\ - & - & - & - & - & - & - & - & - & - & - & - & - \\ 3 {n}_{2}^{2} & 2 {n}_{2} & 1 & 0 & - 3 {n}_{2}^{2} & - 2 {n}_{2} & - 1 & 0 & … & 0 & 0 & 0 & 0 \\ 0 & 0 & 0 & 0 & 3 {n}_{3}^{2} & 2 {n}_{3} & 1 & 0 & … & 0 & 0 & 0 & 0 \\ ⋮ & ⋮ & ⋮ & ⋮ & ⋮ & ⋮ & ⋮ & ⋮ & ⋮ & ⋮ & ⋮ & ⋮ & ⋮\end{matrix} ] [ \begin{matrix}{a}_{1} \\ {b}_{1} \\ {c}_{1} \\ {d}_{1} \\ {a}_{2} \\ {b}_{2} \\ {c}_{2} \\ {d}_{2} \\ ⋮ \\ {a}_{E ‐ 1} \\ {b}_{E ‐ 1} \\ {c}_{E ‐ 1} \\ {d}_{E ‐ 1}\end{matrix} ] = [ \begin{matrix}{e}_{1} \\ {e}_{E} \\ - \\ {e}_{2} \\ {e}_{2} \\ ⋮ \\ {e}_{E ‐ 1} \\ {e}_{E ‐ 1} \\ - \\ 0 \\ ⋮ \\ 0\end{matrix} ]$$

Letting A represent the large matrix, x represent the vector of coefficients a through d, and b represent the vector of known onset modification values gives Ax=b, leading to the vector of desired coefficients x=(A^{T}A)⁻¹A^{T}b.

For convenience, the coefficients a through d can be formatted into groups of four. Additionally, there may be no guarantee that the intervals between user-defined notes are constant, which could complicate using the coefficients in the correct range of notes. Therefore, the vector x can be formatted into the array shown below:

$$[ \begin{matrix}{a}_{1} & {b}_{1} & {c}_{1} \\ ⋮ & ⋮ & ⋮ \\ {a}_{E - 1} & {b}_{E - 1} & {c}_{E - 1}\end{matrix} \begin{matrix}{d}_{1} & {n}_{1} & {n}_{2} \\ ⋮ & ⋮ & ⋮ \\ {d}_{E - 1} & {n}_{E - 1} & {n}_{E}\end{matrix} ]$$

Once the cubic spline algorithm is used on the user-defined onset and offset modification matrices E and O, the outputted sets of cubic polynomial coefficients can be used to find the amount of onset or offset modification for each note in the score (rather than only having the modifications for the notes in the score that the user plotted points for). These can be referred to as the “each-note” modifications.

Using the cubic spline coefficients and interval bounds, the value of onset or offset modification for each note in the score can be found. These each-note modification values e* and o* can be stored in a vector, where 1≤c≤C and C is the number of notes in the score (not the number of notes modified by the user).

A hypothetical 8-note phrase (i.e., C=8) can be used as a non-limiting, illustrative example to more clearly illustrate the processes described in the present disclosure. The example E* and O* matrices compared to the original user-defined matrices E and O for this specific 8-note phrase are shown below:

$$E = [ \begin{matrix} & \\ & \\ {n}_{1} & {e}_{1} \\ & \\ {n}_{2} & {e}_{2} \\ {n}_{3} & {e}_{3} \\ & \\ & \end{matrix} ] \to {E}^{*} = [ \begin{matrix}{n}_{1}^{*} & {e}_{1}^{*} ( = 0 ) \\ {n}_{2}^{*} & {e}_{2}^{*} ( = 0 ) \\ {n}_{3}^{*} & {e}_{3}^{*} \\ {n}_{4}^{*} & {e}_{4}^{*} \\ {n}_{5}^{*} & {e}_{5}^{*} \\ {n}_{6}^{*} & {e}_{6}^{*} \\ {n}_{7}^{*} & {e}_{7}^{*} \\ {n}_{8}^{*} & {e}_{8}^{*} ( = 0 )\end{matrix} ] = [ \begin{matrix}1 & {e}_{1}^{*} \\ 2 & {e}_{2}^{*} \\ 3 & {e}_{3}^{*} \\ 4 & {e}_{4}^{*} \\ 5 & {e}_{5}^{*} \\ 6 & {e}_{6}^{*} \\ 7 & {e}_{7}^{*} \\ 8 & {e}_{8}^{*}\end{matrix} ] \begin{matrix} \\ \\ ( = {e}_{1} ) \\ \\ ( = {e}_{1} ) \\ ( = {e}_{E} = {e}_{3} ) \\ \\ \end{matrix}$$

$$O = [ \begin{matrix} & \\ {n}_{1} & {o}_{1} \\ & \\ {n}_{2} & {o}_{2} \\ & \\ & \\ {n}_{3} & {o}_{3} \\ & \end{matrix} ] \to {O}^{*} = [ \begin{matrix}1 & {o}_{1}^{*} ( = 0 ) \\ 2 & {o}_{2}^{*} \\ 3 & {o}_{3}^{*} \\ 4 & {o}_{4}^{*} \\ 5 & {o}_{5}^{*} \\ 6 & {o}_{6}^{*} \\ 7 & {o}_{7}^{*} \\ 8 & {o}_{8}^{*} ( = 0 )\end{matrix} ] \begin{matrix} \\ ( = {o}_{1} ) \\ \\ ( = {o}_{2} ) \\ \\ \\ ( = {o}_{O} = {o}_{3} ) \\ \end{matrix}$$

In this example, the first user-defined onset modification was actually for the third note in the score. After cubic spline interpolation, this first modification e₁ is now the third each-note modification e₃*. Additionally, using the processes described in the present disclosure, the unmodified beginning notes of the score can be given each-note modifications e₁*, e₂*, and o₁* of 0. The same is done for the last note of the score (e₈* =o₈* =0).

However, a shift in a note's onset and offset should also shift the onset and offset of all notes after that note, so the onset and offset modifications of all preceding notes should also be summed. This means that one more set of new matrices En and O can be defined to account for cumulative modifications.

$${E}^{*} \to {E}^{Ω} = [ \begin{matrix}1 & {e}_{1}^{*} \\ 2 & ( {e}_{1}^{*} + {o}_{1} ) + {e}_{2}^{*} \\ 3 & ( {e}_{1}^{*} + {o}_{1}^{*} + {e}_{2}^{*} + {o}_{2}^{*} ) + {e}_{3}^{*} \\ 4 & ( {e}_{1}^{*} + {o}_{1}^{*} {e}_{3}^{*} + {o}_{3}^{*} ) + {e}_{4}^{*} \\ 5 & ( {e}_{1}^{*} + {o}_{1}^{*} {e}_{4}^{*} + {o}_{4}^{*} ) + {e}_{5}^{*} \\ 6 & ( {e}_{1}^{*} + {o}_{1}^{*} {e}_{5}^{*} + {o}_{5}^{*} ) + {e}_{6}^{*} \\ 7 & ( {e}_{1}^{*} + {o}_{1}^{*} {e}_{6}^{*} + {o}_{6}^{*} ) + {e}_{7}^{*} \\ 8 & ( {e}_{1}^{*} + {o}_{1}^{*} {e}_{7}^{*} + {o}_{7}^{*} ) + {e}_{8}^{*}\end{matrix} ] = [ \begin{matrix}1 & {e}_{1}^{Ω} \\ 2 & {e}_{2}^{Ω} \\ 3 & {e}_{3}^{Ω} \\ 4 & {e}_{4}^{Ω} \\ 5 & {e}_{5}^{Ω} \\ 6 & {e}_{6}^{Ω} \\ 7 & {e}_{7}^{Ω} \\ 8 & {e}_{8}^{Ω}\end{matrix} ]$$

$${O}^{*} \to {O}^{Ω} = [ \begin{matrix}1 & {e}_{1}^{*} + {o}_{1}^{*} \\ 2 & ( {e}_{1}^{*} + {o}_{1} ) + {e}_{2}^{*} + {o}_{2}^{*} \\ 3 & ( {e}_{1}^{*} + {o}_{1}^{*} + {e}_{2}^{*} + {o}_{2}^{*} ) + {e}_{3}^{*} + {o}_{3}^{*} \\ 4 & ( {e}_{1}^{*} + {o}_{1}^{*} {e}_{3}^{*} + {o}_{3}^{*} ) + {e}_{4}^{*} + {o}_{4}^{*} \\ 5 & ( {e}_{1}^{*} + {o}_{1}^{*} {e}_{4}^{*} + {o}_{4}^{*} ) + {e}_{5}^{*} + {o}_{5}^{*} \\ 6 & ( {e}_{1}^{*} + {o}_{1}^{*} {e}_{5}^{*} + {o}_{5}^{*} ) + {e}_{6}^{*} + {o}_{6}^{*} \\ 7 & ( {e}_{1}^{*} + {o}_{1}^{*} {e}_{6}^{*} + {o}_{6}^{*} ) + {e}_{7}^{*} + {o}_{7}^{*} \\ 8 & ( {e}_{1}^{*} + {o}_{1}^{*} {e}_{7}^{*} + {o}_{7}^{*} ) + {e}_{8}^{*} + {o}_{8}^{*}\end{matrix} ] = [ \begin{matrix}1 & {e}_{1}^{Ω} + {o}_{1}^{*} \\ 2 & {e}_{2}^{Ω} + {o}_{2}^{*} \\ 3 & {e}_{3}^{Ω} + {o}_{3}^{*} \\ 4 & {e}_{4}^{Ω} + {o}_{4}^{*} \\ 5 & {e}_{5}^{Ω} + {o}_{5}^{*} \\ 6 & {e}_{6}^{Ω} + {o}_{6}^{*} \\ 7 & {e}_{7}^{Ω} + {o}_{7}^{*} \\ 8 & {e}_{8}^{Ω} + {o}_{8}^{*}\end{matrix} ] = [ \begin{matrix}1 & {o}_{1}^{Ω} \\ 2 & {o}_{2}^{Ω} \\ 3 & {o}_{3}^{Ω} \\ 4 & {o}_{4}^{Ω} \\ 5 & {o}_{5}^{Ω} \\ 6 & {o}_{6}^{Ω} \\ 7 & {o}_{7}^{Ω} \\ 8 & {o}_{8}^{Ω}\end{matrix} ]$$

The final matrix of cumulative offset modifications O also accounts for the onset modifications e* of the preceding notes since these will also shift the chronological locations of the notes. An additional benefit of this cumulative method is that the user will not have to change the offsets of the notes in a score if they only wish to change the score's onsets; the onset modifications will be automatically implemented into the changes for the offset.

The values of e‘ and o’ can now be added to the score's original values of onset and offset, respectively. While onset modifications can be plugged into the score's notes directly, changes to the offset are implemented in a more indirect fashion. Notes have duration as a parameter rather than offset, so the offset modifications oΩ can be added to the onset modifications eΩ before overwriting the original duration values of the score. Once this is done, the score will have a user-defined rubato for every cth note in the score defined by:

$${e}_{c}^{Ω} = ( {e}_{1}^{*} + {o}_{1}^{*} + + {e}_{c - 1}^{*} + {o}_{c - 1}^{*} ) + {e}_{c}^{*} = {\sum }_{k = 1}^{c - 1} ( {e}_{k}^{*} + {o}_{k}^{*} ) + {e}_{c}^{*} \qquad ( 1 )$$

$${o}_{c}^{Ω} = ( {e}_{1}^{*} + {o}_{1}^{*} + + {e}_{c - 1}^{*} + {o}_{c - 1}^{*} ) + {e}_{c}^{*} + {o}_{c}^{*} = {\sum }_{k = 1}^{c} ( {e}_{k}^{*} + {o}_{k}^{*} ) \qquad ( 2 )$$

$$for$$

$$c ∈ {ℤ}^{+} .$$

The definitions of e^{Ω} and o^{Ω} can be explained/validated with a graphical analogy.

By way of example, for a simple two-note phrase the four following types of rubato can be considered: ritardando on both notes, accelerando on both notes, accelerando on the first note followed by ritardando on the second note, and ritardando on the first note followed by accelerando on the second note.

In this example, to describe the relationship between the variables e* and o* and the final shifts e‘ and o’, the user plotted points of onset and offset modification for both notes are assumed as e₁=e₁*, o₁=0₁*, e₂=e₂*, and O₂=o₂* (i.e., this example does not need to implement cubic spline interpolation, which allows for temporarily skipping the process of developing the “each-note” modifications to focus instead on the formulas for e^{Q} and o^{l}).

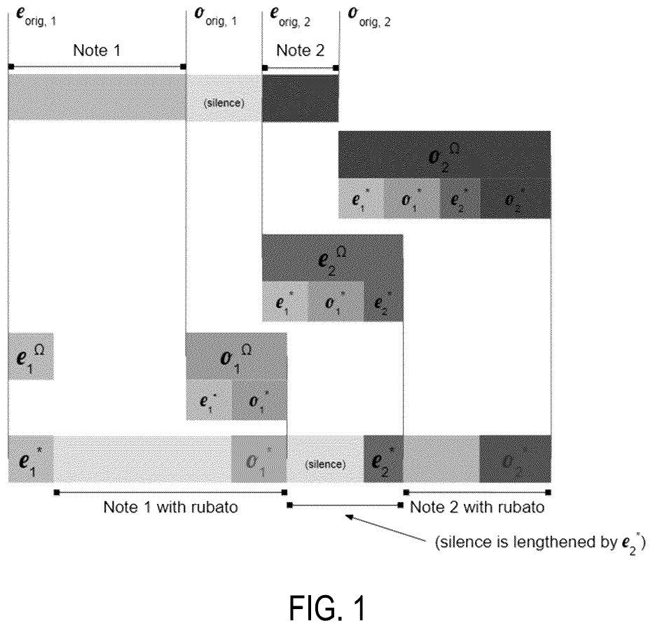

The first instance of rubato to examine is that of ritardando on both notes. In other words, where the user wishes to increase the onset and offset of each note. This can be graphically represented in FIG. 1.

To implement ritardando on both notes, an onset shift of magnitude |e₁*| is added to the onset of the first note, and an offset shift of magnitude |o₁*| is added to the offset of the first note. This now gives the first note an onset at the “end” of |e₁*| and an offset at the “end” of |o₁*|. Since the first note ends at the end of |o₁*|, this is now where the period of silence begins before ending at the end of the second note's onset shift|e₂*|.

It is important to note here that the new length of silence is increased by the magnitude of the onset shift |o₂*|, and that if there is no onset modification on the second note that the length of silence would remain the same as in the original two-note phrase.

A set of onset and offset modifications |e₂*| and |o₂*| similar to those of the first note are also made to the second note. The second note now begins at the end of |e₂*| and ends at the end of |o₂*|. Now, the total change in onset and offset for the first and second notes e₁^{Ω}, o₁^{Ω}, e₂^{Ω}, and o₂^{Ω}can be determined.

Intuitively, one can directly go from onsets and offsets of notes in the original phrase to their ritardando counterparts by accounting for all the changes to the onsets and offsets of the original notes. Taking e₂Ω as an example, it can be observed that a shift of magnitude |e₂*| would be insufficient to take the onset of the second note from its original value to its chronologically delayed ritardando counterpart. Instead, magnitudes of the shifts to the onset and offset of the previous note |e₁*| and |o₁*| must also be added. The same holds true for the total change to the offset of the second note o₂^{Ω}.

From this graphical interpretation, the following equations can be determined:

$${e}_{orig , 1} + \vert {e}_{1}^{Ω} \vert = {e}_{orig , 1} + \vert {e}_{1}^{*} \vert$$

$${o}_{orig , 1} + \vert {o}_{1}^{Ω} \vert = {o}_{orig , 1} + \vert {e}_{1}^{*} \vert + \vert {o}_{1}^{*} \vert$$

$${e}_{orig , 2} + \vert {e}_{2}^{Ω} \vert = {e}_{orig , 2} + \vert {e}_{1}^{*} \vert + \vert {o}_{1}^{*} \vert + \vert {e}_{2}^{*} \vert$$

$${o}_{orig , 2} + \vert {o}_{2}^{Ω} \vert = {o}_{orig , 2} + \vert {e}_{1}^{*} \vert + \vert {o}_{1}^{*} \vert + \vert {e}_{2}^{*} \vert + \vert {o}_{2}^{*} \vert .$$

Using ritardando on both notes implies that all of the onset and offset shifts are to the right, so it can be determined that that e₁*, o₁*, e₂*, and o₂* are all positive, meaning that the above equations can be simplified to:

$${e}_{1}^{Ω} = {e}_{1}^{*}$$

$${o}_{1}^{Ω} = {e}_{1}^{*} + {o}_{1}^{*}$$

$${e}_{2}^{Ω} = {e}_{1}^{*} + {o}_{1}^{*} + {e}_{2}^{*}$$

$${o}_{2}^{Ω} = {e}_{1}^{*} + {o}_{1}^{*} + {e}_{2}^{*} + {o}_{2}^{*} .$$

which then gives Equations (1) and (2).

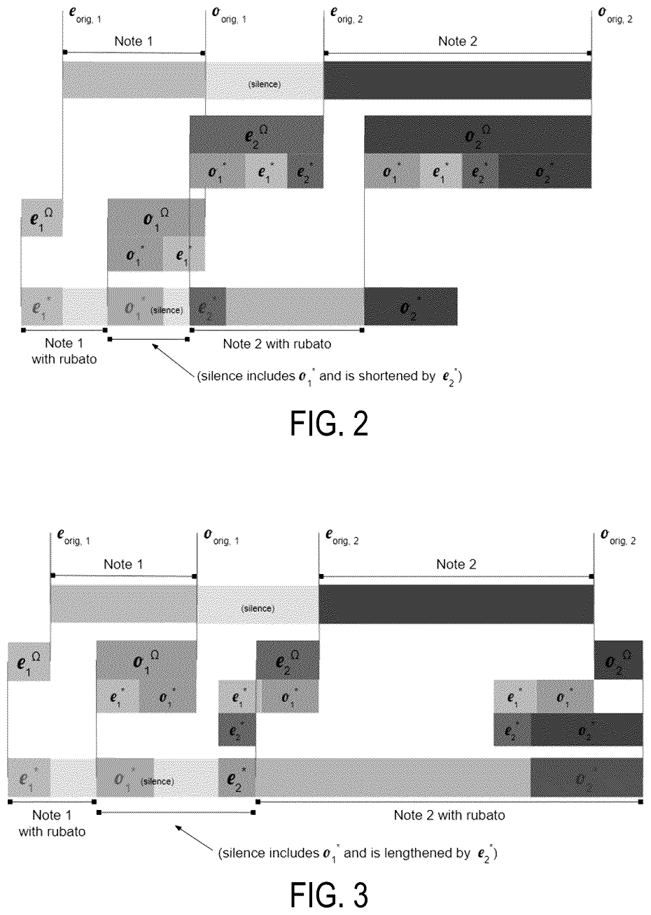

The next instance of rubato examined is that of accelerando on both notes in the same example two-note phrase. Here, the onset and offset of each note are both decreased. This can be graphically illustrated as shown in FIG. 2.

Similar to ritardando on both notes described above, accelerando can be implemented on both notes by applying an onset shift of magnitude |e₁*| to the onset of the first note and an offset shift of magnitude |o₁*| to the offset of the first note. However, because this example is now dealing with accelerando rather than ritardando, these onset and offset shifts are moving the notes in the opposite direction (i.e., left) instead of right. This means that the first note now has an onset at the “start” of e₁* (not the end of e₁* as in ritardando) and an offset at the end of o₁*. Since the first note ends at the end of o₁*, this is now where the period of silence begins before ending at the end of the second note's onset modification e₂*.

It is important to note here that the length of silence includes the magnitude |o₁*|, and that if there is no onset shift on the second note that the length of silence would remain the same as in the original two-note phrase. A set of onset and offset shifts with magnitudes |e₂*| and |o₂*| similar to those of the first note are lastly made to the second note. The second note now begins at the “start” of e* and ends at the “start” of o₂*.

Now, the total change in onset and offset for the first and second notes can be determined. One can again graphically appreciate that in order to move between the onset or offset of a note in the original phrase to its accelerando counterpart, all prior changes to the onsets and offsets of the previous notes must be considered.

Taking e₂^{Ω} as an example, it can be seen that a change of e₂* would be insufficient to take the onset of the second note from its original value to its accelerando counterpart. Instead, the changes to the onset and offset of the previous note e₁* and o₁* must also be added. The same holds true for the total change to the offset of the second note o₂^{Ω}.

From this graphical interpretation, the following equations can be determined:

$${e}_{orig , 1} - \vert {e}_{1}^{Ω} \vert = {e}_{orig , 1} - \vert {e}_{1}^{*} \vert$$

$${o}_{orig , 1} - \vert {o}_{1}^{Ω} \vert = {o}_{orig , 1} - \vert {e}_{1}^{*} \vert - \vert {o}_{1}^{*} \vert$$

$${e}_{orig , 2} - \vert {e}_{2}^{Ω} \vert = {e}_{orig , 2} - \vert {e}_{1}^{*} \vert - \vert {o}_{1}^{*} \vert - \vert {e}_{2}^{*} \vert$$

$${o}_{orig , 2} - \vert {o}_{2}^{Ω} \vert = {o}_{orig , 2} - \vert {e}_{1}^{*} \vert - \vert {o}_{1}^{*} \vert - \vert {e}_{2}^{*} \vert - \vert {o}_{2}^{*} \vert .$$

Using accelerando on both notes implies that all of the onset and offset shifts are to the left, so it can be determined that e₁*, o₁*, e₂*, and o₂* are all negative, meaning that the above equations can be simplified to:

$${e}_{orig , 1} + {e}_{1}^{Ω} = {e}_{orig , 1} + {e}_{1}^{*}$$

$${o}_{orig , 1} + {o}_{1}^{Ω} = {o}_{orig , 1} + {e}_{1}^{*} + {o}_{1}^{*}$$

$${e}_{orig , 2} + {e}_{2}^{Ω} = {e}_{orig , 2} + {e}_{1}^{*} + {o}_{1}^{*} + {e}_{2}^{*}$$

$${o}_{orig , 2} + {o}_{2}^{Ω} = {o}_{orig , 2} + {e}_{1}^{*} + {o}_{1}^{*} + {e}_{2}^{*} + {o}_{2}^{*} ,$$

and then

$${e}_{1}^{Ω} = {e}_{1}^{*}$$

$${o}_{1}^{Ω} = {e}_{1}^{*} + {o}_{1}^{*}$$

$${e}_{2}^{Ω} = {e}_{1}^{*} + {o}_{1}^{*} + {e}_{2}^{*}$$

$${o}_{2}^{Ω} = {e}_{1}^{*} + {o}_{1}^{*} + {e}_{2}^{*} + {o}_{2}^{*} .$$

which then gives Equations (1) and (2).

An example combination of both accelerando and ritardando is now described;

specifically, when the onset and offset of the first note are decreased but the onset and offset of the second note are increased. This can be graphically displayed in FIG. 3.

To implement accelerando on the first note, an onset shift of magnitude |e₁*| is subtracted from the onset of the first note, and an offset shift of magnitude |o₁*| is subtracted from the offset of the first note. This now gives the first note an onset at the “start” of |e₁*| and an offset at the “start” of |o₁*|.

Since the first note ends at the start of |o₁*|, this is now where the period of silence begins. However, because ritardando is being implemented on the second note the silence will not end until the end of the second note's onset shift |e₂*|. In other words, the total length of silence will be increased by the magnitude |e₂*|. The length of silence is not affected by the accelerando of the first note because it is shifted back to the start of |o₁*|, thereby recovering the lost time with |o₁*|.

To implement ritardando on the second note, an onset shift of magnitude |e₂*| is added to the onset of the second note, and an offset shift of magnitude |o₂*| is added to the offset of the second note. The second note now begins at the end of |e₂*| and finishes at the end of |o₂*|.

Now, the total change in onset and offset for the first and second notes can be determined. Intuitively, one can directly go from onsets and offsets of notes in the original phrase to their rubato counterparts by accounting for all the changes to the onsets and offsets of the original notes.

In contrast to the first two examples, e_{c}^{Ω} and o_{c}^{Ω} are now composed of shifts going both left and right. From this graphical interpretation, the following equations can be determined:

$${e}_{orig , 1} - \vert {e}_{1}^{Ω} \vert = {e}_{orig , 1} - \vert {e}_{1}^{*} \vert$$

$${o}_{orig , 1} - \vert {o}_{1}^{Ω} \vert = {o}_{orig , 1} - \vert {e}_{1}^{*} \vert - \vert {o}_{1}^{*} \vert$$

$${e}_{orig , 2} - \vert {e}_{2}^{Ω} \vert = {e}_{orig , 2} - \vert {e}_{1}^{*} \vert - \vert {o}_{1}^{*} \vert - \vert {e}_{2}^{*} \vert$$

$${o}_{orig , 2} + \vert {o}_{2}^{Ω} \vert = {o}_{orig , 2} - \vert {e}_{1}^{*} \vert - \vert {o}_{1}^{*} \vert - \vert {e}_{2}^{*} \vert - \vert {o}_{2}^{*} \vert .$$

Using accelerando on the first note and ritardando on the second note implies that the onset and offset shifts of the first note are to the left, while the onset and offset shifts of the second note are to the right. The onset and offset shifts to the left are defined to be negative, while onset and offset shifts to the right are defined to be positive. In this case, that means e* and o* are negative, while e₂*, and o₂* are positive, resulting in simplification of the above equations to the following:

$${e}_{1}^{Ω} = {e}_{1}^{*}$$

$${o}_{1}^{Ω} = {e}_{1}^{*} + {o}_{1}^{*}$$

$${e}_{2}^{Ω} = {e}_{1}^{*} + {o}_{1}^{*} + {e}_{2}^{*}$$

$${o}_{2}^{Ω} = {e}_{1}^{*} + {o}_{1}^{*} + {e}_{2}^{*} + {o}_{2}^{*} .$$

which then gives Equations (1) and (2).

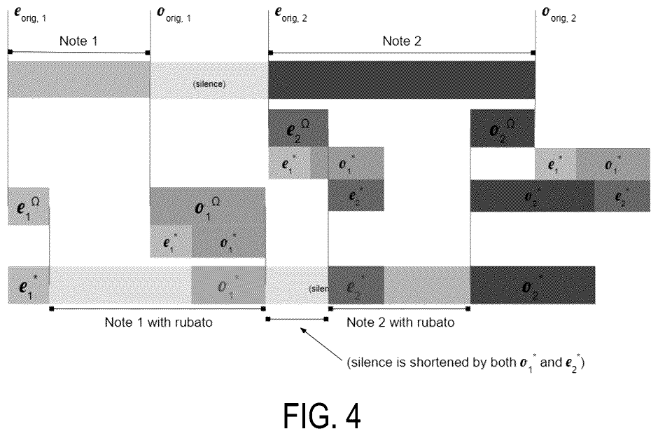

An example combination of both accelerando and ritardando is now described; specifically, increasing the onset and offset of the first note while decreasing the onset and offset of the second note. This can be graphically displayed in FIG. 4.

To implement ritardando on the first note, an onset shift of magnitude |e₁*| is added to the onset of the first note, and an offset shift of magnitude |o₁*| is added to the offset of the first note. This now gives the first note an onset at the “end” of |e₁*| and an offset at the “end” of |o₁*|.

Since the offset of the first note is now at the end of |o₁*|, this is where the period of silence begins. However, because accelerando is being implemented on the second note, the silence will end at the beginning of the second note's onset shift |e₂*|. In other words, the total length of silence will be decreased by the magnitude |e₂*|. The length of silence is not affected by the ritardando of the first note because it is simply shifted to the end of |o₁*|, thereby avoiding any lost time from shifts in the first note.

To implement accelerando on the second note, an onset shift of magnitude |e₂*| is subtracted from the onset of the second note, and an offset shift of magnitude |o₂*| is subtracted from the offset of the second note. The second note now begins at the start of |e₂*| and finishes at the start of |o₂*|.

The total change in onset and offset for the first and second notes can now be determined. Intuitively, one can directly go from onsets and offsets of notes in the original phrase to their rubato counterparts by accounting for all the changes to the onsets and offsets of the original notes. Now, e_{c}^{Ω} and o_{c}^{Ω} are composed of shifts going both left and right. From this graphical interpretation, the following equations can be determined:

$${e}_{orig , 1} + \vert {e}_{1}^{Ω} \vert = {e}_{orig , 1} + \vert {e}_{1}^{*} \vert$$

$${o}_{orig , 1} + \vert {o}_{1}^{Ω} \vert = {o}_{orig , 1} + \vert {e}_{1}^{*} \vert + \vert {o}_{1}^{*} \vert$$

$${e}_{orig , 2} + \vert {e}_{2}^{Ω} \vert = {e}_{orig , 2} + \vert {e}_{1}^{*} \vert + \vert {o}_{1}^{*} \vert - \vert {e}_{2}^{*} \vert$$

$${o}_{orig , 2} - \vert {o}_{2}^{Ω} \vert = {o}_{orig , 2} + \vert {e}_{1}^{*} \vert + \vert {o}_{1}^{*} \vert - \vert {e}_{2}^{*} \vert - \vert {o}_{2}^{*} \vert .$$

Using ritardando on the first note and accelerando on the second note implies that the onset and offset shifts of the first note are to the right, while the onset and offset shifts of the second note are to the left. The onset and offset shifts to the left are defined to be negative, while onset and offset shifts to the right are defined to be positive. In this case, that means e₁* and o₁* are positive, while e₂*, and o₂* are negative, resulting in simplification of the above equations to

$${e}_{1}^{Ω} = {e}_{1}^{*}$$

$${o}_{1}^{Ω} = {e}_{1}^{*} + {o}_{1}^{*}$$

$${e}_{2}^{Ω} = {e}_{1}^{*} + {o}_{1}^{*} + {e}_{2}^{*}$$

$${o}_{2}^{Ω} = {e}_{1}^{*} + {o}_{1}^{*} + {e}_{2}^{*} + {o}_{2}^{*} .$$

which then gives Equations (1) and (2).

One of the consequences of defining rubato as a symbolic operator is that asymptotic tempo becomes a playable, localized form of retrograde. Not only does this provide a definition of retrograde in terms of tempo, but a whole array of localized retrogrades can now be concretely defined using the symbolic rubato model. These localized retrogrades equivalent to asymptotic tempo modification can be referred to as Honeradian retrograde, described in more detail below.

Having the user be able to directly define changes to the symbolic onset and offset of each note in the score allows the user to more easily leverage more nuanced aspects of rubato, such as silence between notes and note-to-note transitions. However, because of the long-standing nature of the tempo-modification model of rubato, it is advantageous to know how changes made in the new symbolic operator model of rubato translate to the tempo-modification model. These formulas connecting the symbolic and tempo-modification models of rubato result in the concept of Honeradian retrograde as asymptotic tempo modification.

For initial note onsets Eᵢ and final, post-modification onsets E_{f}, the modified tempo of the nth note T_{f,n} in the score equivalent to the original onset-modification can be determined through the following equation:

$${T}_{f , n} = \frac{{E}_{i , n} - {E}_{i , n - 1}}{{E}_{f , n} - {E}_{f , n - 1}} {T}_{i , n} , \qquad ( 3 )$$

$$n > 1$$

Conversely, for initial tempos Tⱼ and final, post-modification tempos T_{f}, the onset modification ΔEₙ of the nth note in the score equivalent to the original tempo change can be determined through the following equation:

$$Δ {E}_{n} = \frac{1}{{c}_{n}} ( {E}_{i , n} - {E}_{i , n - 1} ) + {E}_{f , n - 1} - {E}_{i , n} , \qquad ( 4 )$$

$$n > 1 ,$$

$${c}_{n} = \frac{{T}_{f , n}}{{T}_{i , n}} ,$$

$${E}_{f , 0} = {E}_{i , 0} = 0$$

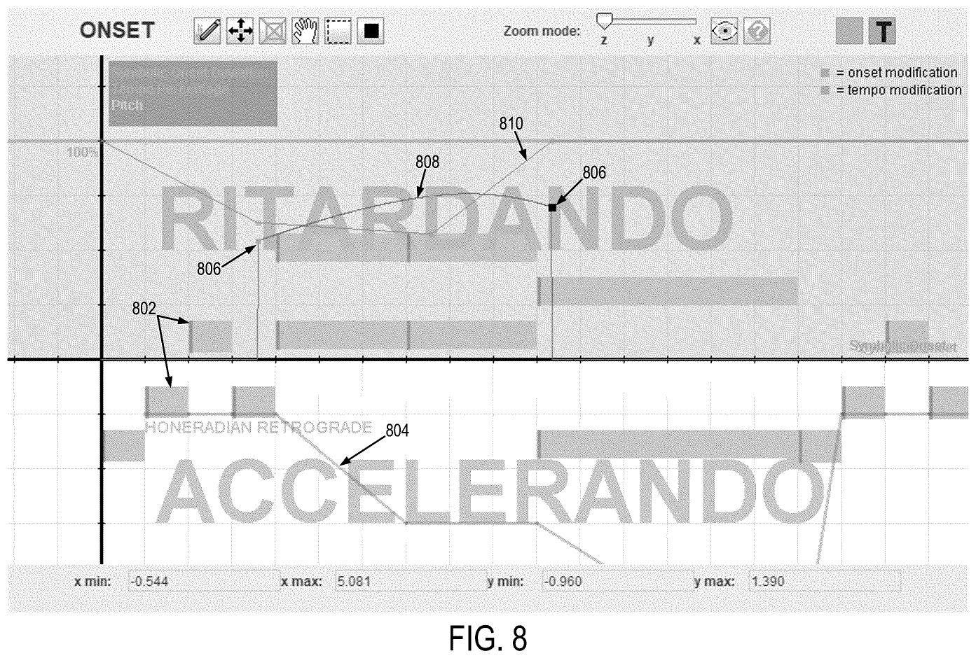

It should be noted that, in practice, this tempo modification equivalent to the user-defined changes to the symbolic onset and offset of notes (and vice versa) is an approximation rather than a conversion. The accuracy of the approximation can be increased or decreased (e.g., via conversion coarseness sliders described below with respect to FIG. 8) by splicing notes into smaller, individually-treated notes.

With equations (3) and (4), the changes in tempo caused by a change in symbolic onset/offset can be approximated, which leads to an important edge case: modifications to symbolic onset and offset that change the ordering of notes.

A straightforward example of this edge case is accelerando of increasingly large magnitude on the symbolic onset of a single note. In the tempo-modification model of rubato, this accelerando would make the note's physical onset approach that of the previous note, eventually creating a chord. However, the symbolic operator model would move the onset of this note increasingly closer to the onset of the previous note before then going past it, thereby changing the ordering of notes.

Looking at equation (4), changing the ordering of notes in the way described can be separated into two halves: the first where the onset of the modified note approaches that of the previous note, and the second where the modified onset passes that of the previous note. Mathematically, since the initial onsets remain unchanged, this causes the equivalent tempo modification for the two halves of this edge case to become

$${T}_{f} = ( {E}_{i , n} - {E}_{i , n - 1} ) {lim}_{x \to {0}^{+}} \frac{1}{x} ,$$

$$x = {E}_{f , n} - {E}_{f , n - 1}$$

$$and$$

$${T}_{f} = ( {E}_{i , n} - {E}_{i , n - 1} ) {lim}_{x \to {0}^{-}} \frac{1}{x} ,$$

$$x = {E}_{f , n} - {E}_{f , n - 1} .$$

This is an asymptotic function with its origin at the symbolic onset of the formerly previous note, meaning that the tempo change required to change the ordering of notes is asymptotic.

Not only does this mean that asymptotic tempo now has defined playable behavior via the symbolic operator model of rubato, but one can also now concretely define a localized retrograde using symbolic rubato.

The symbolic operator model of rubato is able to define retrograde as a form of rubato. More specifically, modeling rubato as a symbolic operator allows for the possibility of accelerando of such a high magnitude that the onset of one note is shifted to before the onset of the previous note, effectively reversing the order of notes.

While the traditional tempo model does not have the flexibility to define retrograde as a form of tempo modification, the symbolic operator model's reliance on symbolic onset allows changes such as asymptotic tempo to become playable forms of retrograde. This is also why the symbolic operator model of rubato deals in symbolic onset rather than duration. Although it may initially seem more intuitive, modeling rubato by extending a note's duration does not allow for changes in note order; this then means that a symbolic duration model of rubato would fail to reveal the conceptual links between retrograde and tempo seen by modifying symbolic onset.

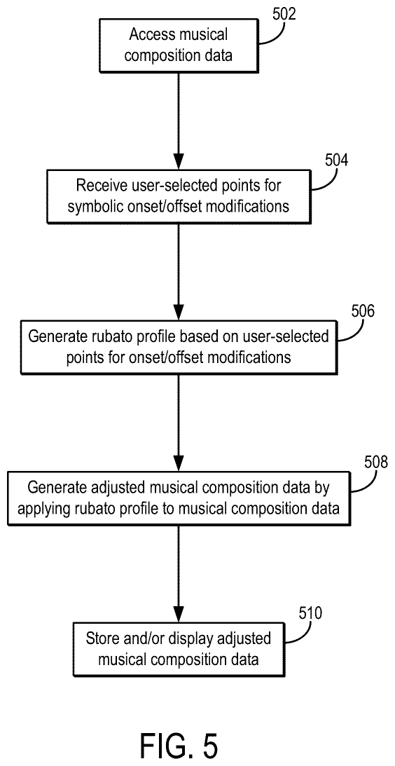

Referring now to FIG. 5, a flowchart is illustrated as setting forth the steps of an example method for adjusting a musical composition based on a computational model of rubato.

The method includes accessing, with a computer system, musical composition data, as indicated at step 502. The musical composition data generally include a sequence of symbolic notes that define a musical composition or score.

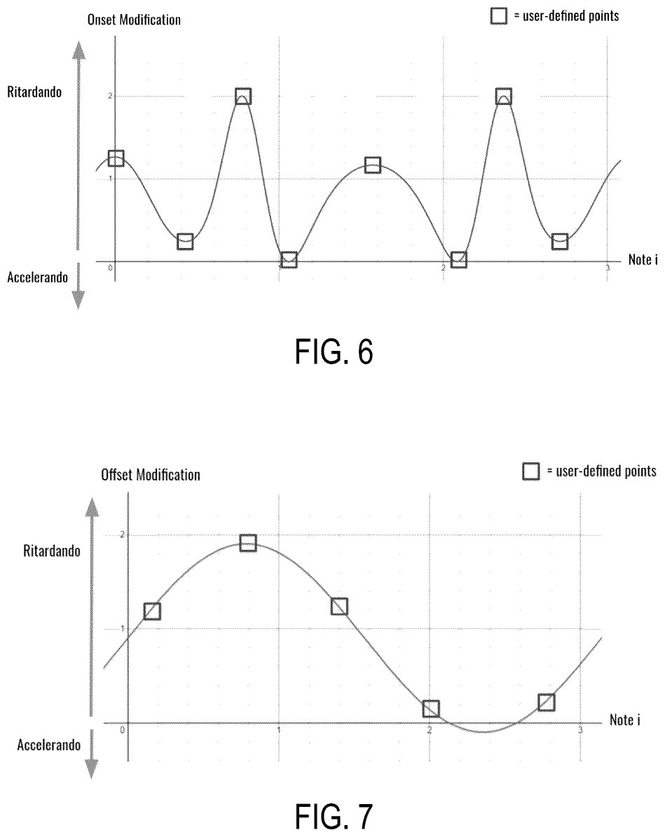

A user then selects one or more points in the musical composition data that should receive a symbolic onset and/or symbolic offset modification, as indicated at step 504. The points can be selected by the user via a GUI generated by the computer system. In some examples, the GUI allows for user inputs, scalability, and adjustments, with quick feedback of the adjustments in the modified musical composition. An example of such a GUI for adjusting onset modifications is illustrated in FIG. 6, and an example of such a GUI for adjusting offset modifications is illustrated in FIG. 7. In the illustrated examples, the GUI can depict two sets of graphs: one for onset modifications and another for offset modifications. Each graph has an x-axis representing the ith note of the score and a y-axis representing the magnitude of onset/offset modification to the ith note. Points representing modifications to onset and offset can be placed on the graph by the user (e.g., by selecting points on the graph via a suitable input, such as a peripheral device, a touch screen input, etc.). Once the cubic spline, or other, interpolation is determined, it can be plotted over the points on the graph(s).

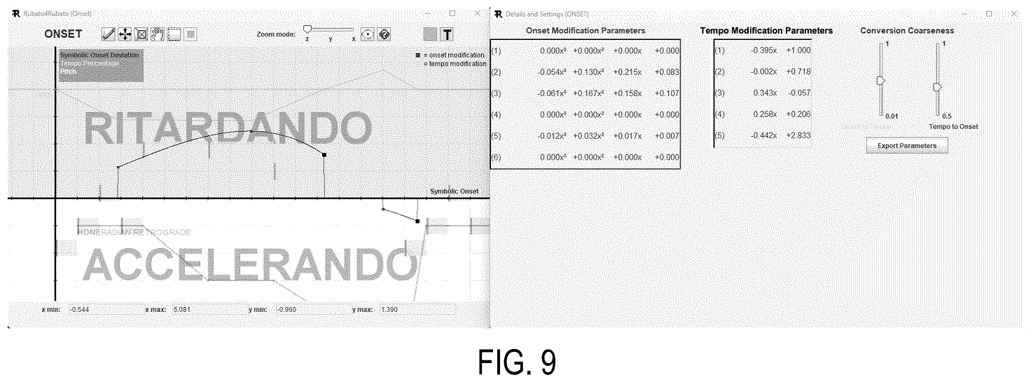

Another example GUI is shown in FIGS. 8 and 9. In this example, the note onsets and durations are displayed similar to a digital audio workstation (“DAW”) format where notes 802 are arranged along the y-axis according to their pitch and the duration of the note 802 is represented along the x-axis. With respect to the onset/offset modifications, the x-axis represents the onset and offsets of the ith note of the score and the y-axis represents the magnitude of onset/offset modification to the ith note. A line referred to as the Honeradian retrograde line 804 can be displayed, which represents a negative number limit on the onset modification graph to prevent the onset of a note from occurring before the onset of the previous note in the musical score. Honeradian Retrograde is defined as when onset modifications are selected to result in a reordering of notes in a musical composition that leads to an asymptotic tempo modification, which would have been previously unplayable. By way of example, consider two notes within a musical composition, where the first note occurs in time before the second note (i.e., the first note is earlier in the score than the second note). When an onset modification applied to the second note causes the onset of that second note to occur before the onset of the first note, the changing in the ordering of these notes will result in an asymptotic tempo change. It is an advantage of the systems and methods described in the present disclosure that this asymptotic tempo can still be played by recognizing the asymptotic tempo as a reordering of the notes based on their onset modifications using a computational model of rubato.

As shown in FIG. 8, the user selects points 806 via the GUI, where the positive y-values for a point 806 indicate a positive onset modification, and the negative values for a point 806 indicate a negative onset modification. A cubic spline 808 is computed as described above and displayed on the GUI to indicate the rubato profile for adjusting other notes 802 in the musical composition. The GUI can also display the resulting tempo modification 810 that will occur when converting the rubato profile to tempo modifications for performing the musical composition.

The symbolic onset and/or offset modifications can be applied to individual notes, as described above, or in some implementations to chords. Since the onsets and offsets of the notes in a chord are typically the same, the cumulative approach described above would currently shift the chords too much, since it would consider the onset and offset of each note separately. To circumvent this, each chord can be grouped into a set of notes that receives onset and offset values to avoid the cumulative effects of the individual onsets and offsets of the notes inside the chord.

Referring again to FIG. 5, after the user selects points for onset and/or offset modification, the rubato profile is generated, as indicated at step 506. As described above, the rubato profile can be generated based on an interpolation or other curve fitting technique or algorithm. As a non-limiting example, the rubato profile can be generated using a cubic spline interpolation between the user-selected points. Adjusted musical composition data are then generated using the rubato profile, as indicated at step 508. For instance, the rubato profile can be converted into tempo modifications that are applied to the original musical composition data. Additionally or alternatively, the rubato profile can be used to adjust other parameters of the musical composition data, such as the pitch or loudness of notes in the musical score. Furthermore, the rubato profile can be applied to individually change the timings of notes in an individual voice in the musical composition data, can be applied to change the timings of two or more voices in the musical composition data, or can be applied to change the timings of all voices in the musical composition data. The adjusted musical composition data are then stored for later use, displayed to the user, or both, as indicated at step 510.

As one example, the adjusted musical composition data can be processed by a computer system to generate an electronic musical recording from the adjusted composition data. As another example, the adjusted musical composition data can be sent, via the computer, to a musician for performance. The adjusted musical composition data can be sent in an electronic format, or in some other instances can be converted onto a printed media, such as by printing the adjusted musical composition data in a written format using standard musical notations.

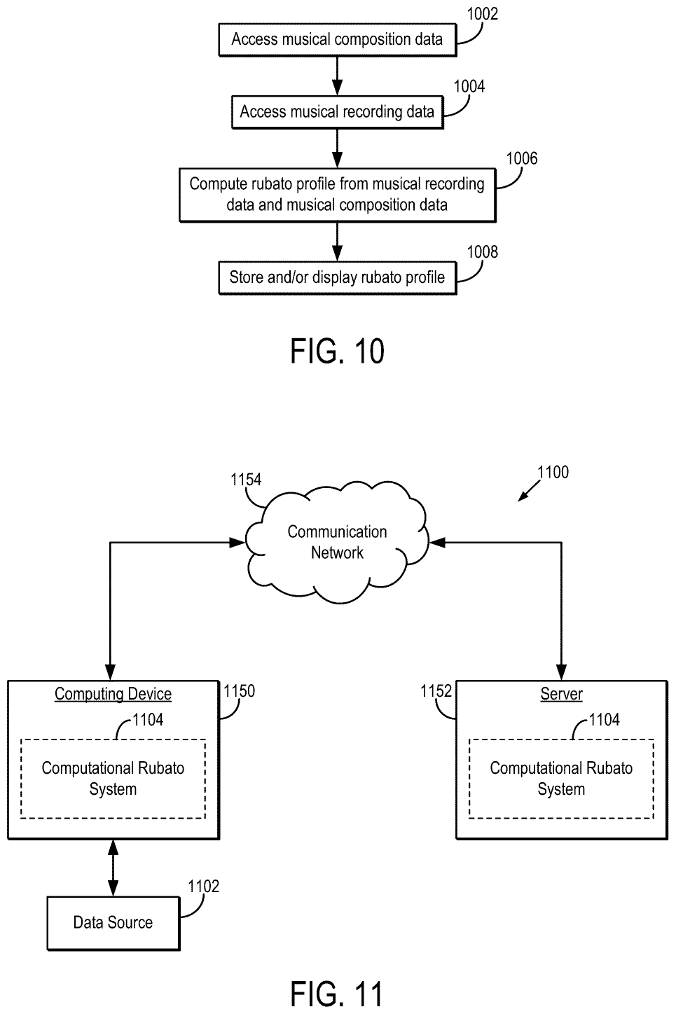

Referring now to FIG. 10, a flowchart is illustrated as setting forth the steps of an example method for determining a rubato profile from a musical recording using a computation model of rubato.

The method includes accessing, with a computer system, musical composition data, as indicated at step 1002. The musical composition data generally include a sequence of symbolic notes that define a musical composition or score. The method also includes accessing, with the computer system, musical recording data that include an audio recording of a performance of the musical composition represented by the musical composition data, as indicated at step 1004.

Using the methods described in the present disclosure, the musical recording data can be analyzed using a computational model of rubato in order to extract, compute, or otherwise determine a rubato profile for the musical recording relative to the original musical composition represented by the musical composition data, as indicated at step 1006. For example, the musical recording data can be converted into a suitable digital format (e.g., a DAW representation of the recorded musical piece) and based on a comparison of the recording relative to the original composition, onset modifications, offset modifications, and/or tempo modifications can be determined. The computational model of rubato can be applied to these modifications to determine a rubato profile for the recorded musical piece.

The rubato profile is then stored by the computer system for later use or analysis, as indicated at step 1008. Advantageously, the rubato profile can provide a quantification of the rubato applied when performing the musical composition, as recorded in the musical recording data. As described above, this rubato profile can be used as a way to characterize the musical recording. In some instances, the rubato profile can be used as training data for a machine learning or other AI-based recommender system, such as those used for recommending music to a user of a music streaming service, or the like. Similarly, the rubato profile can be stored and used as an input to such a recommender system. For instance, a user may input the rubato profile for a musical recording that is preferred by the user, and the recommender system may generate an output that includes a list of musical performances having a similar rubato profile.

Additionally or alternatively, the rubato profile can be used as an input to a machine learning or other AI-based model that has been trained to select musical recordings that can elicit a therapeutic effect for a user. For example, a machine learning or other AI-based model can be trained on training data that includes a musical recording, a rubato profile for the musical recording, and feedback data indicating whether a user experienced or otherwise reported a therapeutic effect (e.g., reduced stress) when listening to the musical recording.

As described above, the systems and methods described in the present disclosure can be implemented via a graphical user interface (GUI). The GUI allows user-defined points to be placed on a graph of symbolic onset and offset modifications.

The example GUI (e.g., the GUI illustrated in FIG. 8) can be composed of three graphs superimposed on top of one another, which the user can use to plot points. Because rubato involves changing both the symbolic onsets and offsets of notes, two sets of these graphs are provided (one to modify onset, the other offset). Without loss of generality, the onset aspects of the example GUI are described here; the offset aspects work similarly.

The first of the three superimposed graphs is the onset-pitch graph. This graph is designed to contain a visual representation of a symbolic score's onset and pitch. As the name suggests, the graph's x-axis is the symbolic onset of a note, and the graph's y-axis is the symbolic pitch of a note. For the sake of user convenience, the y-coordinate of the origin of the graph is shifted to the average pitch of all the notes of the score so that the user's view is centered. This view of the score is similar to the piano-roll notation used in Digital Audio Workstations (DAWs). Additionally, depending on whether one is working with symbolic onset or offset, a darkened line will appear at the beginning or end of each note, respectively.

This graph simply shows a user where they are in the score, and the score does not change in any way from this display process. To actually begin modifying the timings of notes in the score, the user must plot points on the symbolic onset/offset deviation graph.

To shift the symbolic onset/offset of a note, the user must plot a point on the onset/offset deviation graph (e.g., points 806). This graph has the same x-axis as the symbolic onset-pitch graph (symbolic onset), but its y-axis represents how much the onset/offset should change. For example, if a user plots a point with an x-coordinate corresponding to the onset of the fifth note in a score and a y-coordinate of 0.75, then the symbolic onset of the fifth note in the score will be delayed by three quarter notes.

As described above, since the user likely intends for there to be a ripple effect when delaying a single note, all other notes after a shifted note will also be shifted. This means that in the example in the previous paragraph, all notes after the fifth note in the score will also be delayed by three quarter notes.

Since positive onset deviations delay notes and negative onset deviations make notes come earlier, the positive y-axis of this graph is labeled as ritardando, while the negative y-axis of the graph is labeled as accelerando. This references the definition of rubato described above, where accelerando and ritardando are treated as modifications to the onsets and offsets of notes rather than to tempo.

The last of the three graphs in the example GUI is the tempo percentage graph. Like the other two graphs, the x-axis of the tempo percentage graph is symbolic onset, and as the name suggests, the y-axis of the tempo-percentage graph is the percentage of the original tempo that some note has given some modification to its symbolic onset and/or offset.

While the computational model of rubato described in the present disclosure mainly focuses on the definition of rubato as changes to the symbolic onset and offset of notes, it is noted that rubato as tempo modification is a much more well-known model of rubato. In these instances, tempo modifications equivalent to changes to the symbolic onset and/or offset of notes in the score can be approximated.

In addition to the three superimposed graphs, the GUI also contains a line 804 indicating Honeradian retrograde as shown in FIG. 8. To avoid unintentional Honeradian retrograde, the line 804 can be implemented to indicate to the user a boundary past which any placed points 806 will result in the changing of the order of notes.

A user can interact with the GUI using a number of different inputs and tools. From left to right in FIG. 8, example tools can include: Draw (creates a point), Move (moves a selection of points), Erase (erases a point or selection of points), Pan (moves the user's view of the graph), Select (selects points), Stop Point (places a point to end a series of spline modifications at a specific note before the last note in the score), Zoom Dimension Slider (allows the user to specify whether they wish to magnify the x-axis, y-axis, or both), Spline Parameters Window (described below), Help (opens a help window with descriptions of all the tools), Onset Modification Mode (allows the user to implement rubato by modifying the symbolic onsets/offsets of notes), and Tempo Modification Mode (allows the user to implement rubato by modifying the tempos of notes. The onset modification mode can be set as the default editing mode and can be intended to be the main method of modifying timings of notes in the symbolic score. The tempo modification model can be used a middle ground for users more accustomed to the tempo modification model of rubato. It is possible to approximate one editing mode using the other.

The spline parameters window noted above allows the user to see the actual values of the cubic spline, or other curve fitting, parameters being used to implement rubato over a defined set of points. Referencing to the example illustrated in FIG. 9, the Onset Modification Parameters describe the splines (or lack of) used for each interval of user-defined points. Then, using the equations described above to approximate the equivalent change to tempo, a list of lines and their parameters is shown in the Tempo Modification Parameters section.

Lastly, since the formula to find a tempo change equivalent to a symbolic onset/offset change (and vice versa) is an approximation, the resolution of this conversion can be changed in the Conversion Coarseness section of the spline parameters window. When increasing the resolution, notes of the actual symbolic score are spliced into multiple smaller imaginary notes, allowing for a finer approximation of tempo change as well as the ability for tempo to change between notes as described above.

Once the user has implemented rubato on a symbolic score through some set of points, they can save the data as a separate file for later use and/or additional analysis. In some implementations, the following data can be exported: the values of the cubic spline parameters used to generate the splines from user-defined points; the intervals over which the cubic splines are used, which is determined by the x-coordinates of the user-defined points; the values of the linear spline parameters used to generate the approximate tempo modifications equivalent to the symbolic onset/offset modifications; and the intervals over which the linear splines are used (determined in the same manner as the intervals for the cubic splines).

In addition to simple monophonic melodies, the systems and methods described in the present disclosure can also handle the edge case of symbolic scores with chords as shown in FIG. 8. Since the onsets and offsets of the notes in a chord are typically the same, the cumulative shift approach defined above may offset the chords too much, since it would consider the onset and offset of each note separately. To circumvent this, the onsets of notes can be compared to the onsets of their neighbors. If their onsets match, they can be considered to be in a chord, and the cumulative effects of the individual onsets and offsets of the chordal notes can be ignored.

In some implementations, hierarchical modifications of symbolic onset and/or offset modifications may be used. In these instances, the methodologies used to “split” notes for higher-resolution tempo-approximation described above can be extended to modifications over different voices in the symbolic score. One could then plot spline changes for those specific regions while leaving the overarching score-spanning spline changes untouched, leading to children hierarchies of symbolic rubato.

FIG. 11 shows an example of a system 1100 for adjusting a musical composition using a computation model of rubato, extracting a rubato profile from a musical recording, or both, in accordance with some embodiments of the systems and methods described in the present disclosure. As shown in FIG. 11, a computing device 1150 can receive one or more types of data (e.g., musical composition data, musical recording data) from data source 1102. In some embodiments, computing device 1150 can execute at least a portion of a computational rubato system 1104 to adjust musical composition data and/or extract a rubato profile from data received from the data source 1102.

Additionally or alternatively, in some embodiments, the computing device 1150 can communicate information about data received from the data source 1102 to a server 1152 over a communication network 1154, which can execute at least a portion of the computational rubato system 1104. In such embodiments, the server 1152 can return information to the computing device 1150 (and/or any other suitable computing device) indicative of an output of the computational rubato system 1104.

In some embodiments, computing device 1150 and/or server 1152 can be any suitable computing device or combination of devices, such as a desktop computer, a laptop computer, a smartphone, a tablet computer, a wearable computer, a server computer, a virtual machine being executed by a physical computing device, and so on. The computing device 1150 and/or server 1152 can also reconstruct images from the data.

In some embodiments, data source 1102 can be any suitable source of data (e.g., musical composition data, musical recording data, other audio/video data, previously generated rubato profiles), such as another computing device (e.g., a server storing musical composition data, musical recording data, previously generated rubato profiles), and so on. In some embodiments, data source 1102 can be local to computing device 1150. For example, data source 1102 can be incorporated with computing device 1150 (e.g., computing device 1150 can be configured as part of a device for measuring, recording, estimating, acquiring, or otherwise collecting or storing data). As another example, data source 1102 can be connected to computing device 1150 by a cable, a direct wireless link, and so on. Additionally or alternatively, in some embodiments, data source 1102 can be located locally and/or remotely from computing device 1150, and can communicate data to computing device 1150 (and/or server 1152) via a communication network (e.g., communication network 1154).

In some embodiments, communication network 1154 can be any suitable communication network or combination of communication networks. For example, communication network 1154 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), other types of wireless network, a wired network, and so on. In some embodiments, communication network 1154 can be a local area network, a wide area network, a public network (e.g., the Internet), a private or semi-private network (e.g., a corporate or university intranet), any other suitable type of network, or any suitable combination of networks. Communications links shown in FIG. 11 can each be any suitable communications link or combination of communications links, such as wired links, fiber optic links, Wi-Fi links, Bluetooth links, cellular links, and so on.

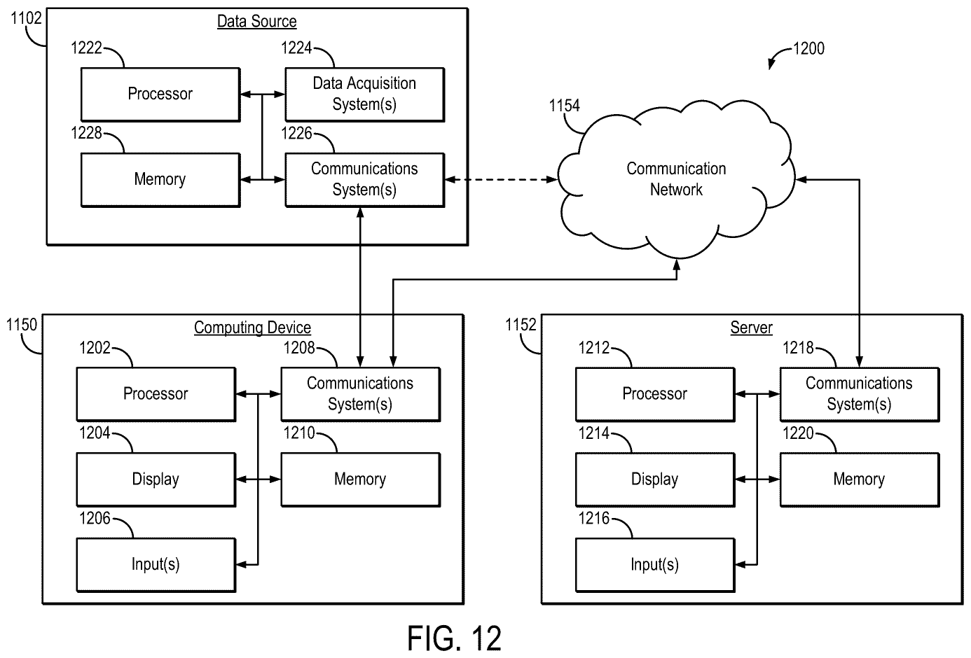

Referring now to FIG. 12, an example of hardware 1200 that can be used to implement data source 1102, computing device 1150, and server 1152 in accordance with some embodiments of the systems and methods described in the present disclosure is shown.

As shown in FIG. 12, in some embodiments, computing device 1150 can include a processor 1202, a display 1204, one or more inputs 1206, one or more communication systems 1208, and/or memory 1210. In some embodiments, processor 1202 can be any suitable hardware processor or combination of processors, such as a central processing unit (“CPU”), a graphics processing unit (“GPU”), and so on. In some embodiments, display 1204 can include any suitable display devices, such as a liquid crystal display (“LCD”) screen, a light-emitting diode (“LED”) display, an organic LED (“OLED”) display, an electrophoretic display (e.g., an “e-ink” display), a computer monitor, a touchscreen, a television, and so on. In some embodiments, inputs 1206 can include any suitable input devices and/or sensors that can be used to receive user input, such as a keyboard, a mouse, a touchscreen, a microphone, and so on.

In some embodiments, communications systems 1208 can include any suitable hardware, firmware, and/or software for communicating information over communication network 1154 and/or any other suitable communication networks. For example, communications systems 1208 can include one or more transceivers, one or more communication chips and/or chip sets, and so on. In a more particular example, communications systems 1208 can include hardware, firmware, and/or software that can be used to establish a Wi-Fi connection, a Bluetooth connection, a cellular connection, an Ethernet connection, and so on.

In some embodiments, memory 1210 can include any suitable storage device or devices that can be used to store instructions, values, data, or the like, that can be used, for example, by processor 1202 to present content using display 1204, to communicate with server 1152 via communications system(s) 1208, and so on. Memory 1210 can include any suitable volatile memory, non-volatile memory, storage, or any suitable combination thereof. For example, memory 1210 can include random-access memory (“RAM”), read-only memory (“ROM”), electrically programmable ROM (“EPROM”), electrically erasable ROM (“EEPROM”), other forms of volatile memory, other forms of non-volatile memory, one or more forms of semi-volatile memory, one or more flash drives, one or more hard disks, one or more solid state drives, one or more optical drives, and so on. In some embodiments, memory 1210 can have encoded thereon, or otherwise stored therein, a computer program for controlling operation of computing device 1150. In such embodiments, processor 1202 can execute at least a portion of the computer program to present content (e.g., images, user interfaces, graphics, tables), receive content from server 1152, transmit information to server 1152, and so on. For example, the processor 1202 and the memory 1210 can be configured to perform the methods described herein (e.g., the method of FIG. 5, the method of FIG. 10).

In some embodiments, server 1152 can include a processor 1212, a display 1214, one or more inputs 1216, one or more communications systems 1218, and/or memory 1220. In some embodiments, processor 1212 can be any suitable hardware processor or combination of processors, such as a CPU, a GPU, and so on. In some embodiments, display 1214 can include any suitable display devices, such as an LCD screen, LED display, OLED display, electrophoretic display, a computer monitor, a touchscreen, a television, and so on. In some embodiments, inputs 1216 can include any suitable input devices and/or sensors that can be used to receive user input, such as a keyboard, a mouse, a touchscreen, a microphone, and so on.

In some embodiments, communications systems 1218 can include any suitable hardware, firmware, and/or software for communicating information over communication network 1154 and/or any other suitable communication networks. For example, communications systems 1218 can include one or more transceivers, one or more communication chips and/or chip sets, and so on. In a more particular example, communications systems 1218 can include hardware, firmware, and/or software that can be used to establish a Wi-Fi connection, a Bluetooth connection, a cellular connection, an Ethernet connection, and so on.

In some embodiments, memory 1220 can include any suitable storage device or devices that can be used to store instructions, values, data, or the like, that can be used, for example, by processor 1212 to present content using display 1214, to communicate with one or more computing devices 1150, and so on. Memory 1220 can include any suitable volatile memory, non-volatile memory, storage, or any suitable combination thereof. For example, memory 1220 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 1220 can have encoded thereon a server program for controlling operation of server 1152. In such embodiments, processor 1212 can execute at least a portion of the server program to transmit information and/or content (e.g., data, images, a user interface) to one or more computing devices 1150, receive information and/or content from one or more computing devices 1150, receive instructions from one or more devices (e.g., a personal computer, a laptop computer, a tablet computer, a smartphone), and so on.

In some embodiments, the server 1152 is configured to perform the methods described in the present disclosure. For example, the processor 1212 and memory 1220 can be configured to perform the methods described herein (e.g., the method of FIG. 5, the method of FIG. 10).

In some embodiments, data source 1102 can include a processor 1222, one or more data acquisition systems 1224, one or more communications systems 1226, and/or memory 1228. In some embodiments, processor 1222 can be any suitable hardware processor or combination of processors, such as a CPU, a GPU, and so on. In some embodiments, the one or more data acquisition systems 1224 are generally configured to acquire data, audio data, video data, or combinations thereof. Additionally or alternatively, in some embodiments, the one or more data acquisition systems 1224 can include any suitable hardware, firmware, and/or software for coupling to and/or controlling operations of a musical recording system, a computing device for generating musical composition data, or so on. In some embodiments, one or more portions of the data acquisition system(s) 1224 can be removable and/or replaceable.

Note that, although not shown, data source 1102 can include any suitable inputs and/or outputs. For example, data source 1102 can include input devices and/or sensors that can be used to receive user input, such as a keyboard, a mouse, a touchscreen, a microphone, a trackpad, a trackball, and so on. As another example, data source 1102 can include any suitable display devices, such as an LCD screen, an LED display, an OLED display, an electrophoretic display, a computer monitor, a touchscreen, a television, etc., one or more speakers, and so on.

In some embodiments, communications systems 1226 can include any suitable hardware, firmware, and/or software for communicating information to computing device 1150 (and, in some embodiments, over communication network 1154 and/or any other suitable communication networks). For example, communications systems 1226 can include one or more transceivers, one or more communication chips and/or chip sets, and so on. In a more particular example, communications systems 1226 can include hardware, firmware, and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, and so on.

In some embodiments, memory 1228 can include any suitable storage device or devices that can be used to store instructions, values, data, or the like, that can be used, for example, by processor 1222 to control the one or more data acquisition systems 1224, and/or receive data from the one or more data acquisition systems 1224; to generate images or other content from data; present content (e.g., data, images, a user interface) using a display; communicate with one or more computing devices 1150; and so on. Memory 1228 can include any suitable volatile memory, non-volatile memory, storage, or any suitable combination thereof. For example, memory 1228 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 1228 can have encoded thereon, or otherwise stored therein, a program for controlling operation of data source 1102. In such embodiments, processor 1222 can execute at least a portion of the program to generate images, transmit information and/or content (e.g., data, images, a user interface, haptic feedback) to one or more computing devices 1150, receive information and/or content from one or more computing devices 1150, receive instructions from one or more devices (e.g., a personal computer, a laptop computer, a tablet computer, a smartphone, etc.), and so on.

In some embodiments, any suitable computer-readable media can be used for storing instructions for performing the functions and/or processes described herein. For example, in some embodiments, computer-readable media can be transitory or non-transitory. For example, non-transitory computer-readable media can include media such as magnetic media (e.g., hard disks, floppy disks), optical media (e.g., compact discs, digital video discs, Blu-ray discs), semiconductor media (e.g., RAM, flash memory, EPROM, EEPROM), any suitable media that is not fleeting or devoid of any semblance of permanence during transmission, and/or any suitable tangible media. As another example, transitory computer-readable media can include signals on networks, in wires, conductors, optical fibers, circuits, or any suitable media that is fleeting and devoid of any semblance of permanence during transmission, and/or any suitable intangible media.

As used herein in the context of computer implementation, unless otherwise specified or limited, the terms “component,” “system,” “module,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

The present disclosure has described one or more preferred embodiments, and it should be appreciated that many equivalents, alternatives, variations, and modifications, aside from those expressly stated, are possible and within the scope of the invention.

1. A method for generating an adjusted musical composition, the method comprising:
(a) accessing musical composition data with a computer system, the musical composition data comprising notes arranged in a temporal sequence;
(b) receiving, by the computer system, at least one user-selected note in the musical composition data;
(c) generating modified notes by using the computer system to apply at least one of an onset modification or an offset modification for each user-selected note;
(d) generating a rubato profile by performing a curve fitting on the modified notes using the computer system;
(e) generating adjusted musical composition data using the computer system by applying at least one of onset modifications or offset modifications to other notes in the musical composition data using the rubato profile; and
(f) storing the adjusted musical composition data with the computer system.

2. The method of claim 1, wherein the rubato profile is generated by performing a curve fitting between user-selected points associated with the modified notes.

3. The method of claim 2, wherein the curve fitting between user-selected points comprises a curve fitting algorithm.

4. The method of claim 3, wherein the curve fitting algorithm comprises a cubic spline interpolation.

5. The method of claim 3, wherein adjusting the musical composition data include applying the at least one of the onset modifications or the offset modifications to other notes in the musical composition data based on coefficients generated by the curve fitting algorithm.

6. The method of claim 5, wherein the curve fitting algorithm comprises a cubic spline interpolation and the coefficients comprise cubic spline coefficients.

7. The method of claim 1, wherein generating the adjusted musical composition data comprises converting the rubato profile to tempo modifications and applying the tempo modifications to the musical composition data.

8. The method of claim 1, wherein the musical composition data includes at least a first note occurring in time before a second note, and the modified notes comprise an onset of the second note being modified to occur in time before an onset of the first note.

9. The method of claim 8, wherein the adjusted musical composition data include an asymptotic tempo based on the onset of the second note being modified to occur in time before the onset of the first note.

10. The method of claim 1, wherein the musical composition data includes at least a first note occurring in time before a second note, and the modified notes comprise an offset of the second note being modified to occur in time before an offset of the first note.

11. The method of claim 1, wherein the modified notes are generated using the computer system to apply at least one of a symbolic onset modification or a symbolic offset modification for each user-selected note.

12. The method of claim 1, wherein the adjusted musical composition is generated using the computer system by applying at least one of symbolic onset modifications or symbolic offset modifications to the other notes in the musical composition.

13. A method for determining a rubato profile for a musical recording, the method comprising:
(a) accessing musical composition data with a computer system, the musical composition data comprising notes arranged in a temporal sequence that define a musical score;
(b) accessing musical recording data with the computer system, the musical recording data comprising an audio recording of a performance of the musical score represented by the musical composition data;
(c) determining, by the computer system, a rubato profile for the musical recording data based on a comparison of the musical recording data and the musical composition data; and
(d) storing the rubato profile with the computer system.

14. The method of claim 13, wherein determining the rubato profile includes determining at least one of onset modifications or offset modifications in the musical recording data based on the comparison of the musical recording data and the musical composition data, wherein the at least one of onset modifications or offset modifications define the rubato profile.

15. The method of claim 14, wherein determining the rubato profile further includes identifying modified notes based on the at least one of onset modifications or offset modifications and performing a curve fitting on the modified notes to generate the rubato profile.

16. The method of claim 15, wherein the curve fitting comprises a cubic spline interpolation.

17. The method of claim 13, further comprising generating a training data set with the computer system, wherein the training data set includes the rubato profile and the musical recording data.

18. The method of claim 17, further comprising training a machine learning model on the training data set, wherein the machine learning model is trained as a recommender system to recommend a musical recording to a user based on a corresponding rubato profile.

19. The method of claim 13, further comprising analyzing the rubato profile with the computer system to identify at least one of a pattern or a metric of the rubato profile that is associated with a therapeutic effect of changing timing in music.
